(19) United States
(12) Patent Application Publication
(10) Pub. No.: US 2012/0026118 A1
(43) Pub. Date: Feb. 2, 2012

(54) MAPPING TRACKPAD OPERATIONS TO TOUCHSCREEN EVENTS

(75) Inventor: Dianne K. Hackborn, Santa Clara, CA (US)

(73) Assignee: GOOGLE INC., Mountain View, CA (US)

(21) Appl. No.: 13/249,395

(22) Filed: Sep. 30, 2011

Related U.S. Application Data
(63) Continuation of application No. 12/845,532, filed on Jul. 28, 2010.

(51) Int. Cl. G06F 3/041

(52) U.S. Cl. 345/173

(57) ABSTRACT

In general, this disclosure describes techniques for mapping trackpad interactions and operations to touchscreen events without the use of a touchscreen user interface. In one example, a method includes receiving, via a trackpad device coupled to a computing device, touch-based input comprising one or more gestures, wherein the trackpad device is physically distinct from a display device coupled to the computing device. The method further includes determining, by the computing device, a trackpad operation based upon the touch-based input, and determining, by the computing device, a touchscreen event based upon a mapping of the trackpad operation to the touchscreen event, wherein the touchscreen event is determined without receiving any user input from a touchscreen device. The method further includes generating, by the computing device, the touchscreen event for processing by an application executing on the computing device, wherein the application is designed to process touchscreen events initiated by touchscreen devices.

This application is a continuation of U.S. application Ser. No. 12/845,532, filed Jul. 28, 2010, the entire contents of which is incorporated herein by reference.

### TECHNICAL FIELD

This disclosure relates to data processing on a computing device.

### BACKGROUND

A user may often interact with a computing device (e.g., mobile phone, personal data assistant, smart phone, or the like) to provide manual user input. For instance, a user may use a keyboard, mouse, trackpad, touchscreen, or other user interface to provide input during execution of one or more applications on the computing device.

In many instances, users may interact with mobile computing devices via touchscreen or trackpad devices by providing touch-based input (e.g., one or more touch gestures) recognized by these devices. Touchscreen devices allow a user to provide direct interaction with a computing device, while trackpad devices typically provide indirect interaction that has been modeled from mouse-based interfaces.

### SUMMARY

In general, this disclosure describes techniques for mapping trackpad interactions and operations to touchscreen events without the use of a touchscreen user interface. For example, a computing device (e.g., mobile computing device, desktop device) may include or be coupled to a pointing device, such as a trackpad device, but may or may not be coupled to a separate touchscreen device. Trackpad operations may be directly mapped to touchscreen events, which may be processed by applications that may be configured to process such events (e.g., applications and/or operating systems designed around a touchscreen user interface). For example, certain tap or multi-touch operations input via a trackpad device may be mapped to corresponding touchscreen events that may then be processed by such applications. In such fashion, a computing device may be capable of processing touchscreen-based events for applications that are configured to process such events during execution on the computing device, regardless of whether the computing device is or is not coupled to a touchscreen device.

In one example, a computer-readable storage medium includes instructions that, when executed, cause one or more processors of a computing device to: receive, via a trackpad device coupled to the computing device, touch-based input comprising one or more gestures, wherein the trackpad device is physically distinct from a display device coupled to the computing device; determine a trackpad operation based upon the touch-based input; determine a touchscreen event based upon a mapping of the trackpad operation to the touchscreen event, wherein the touchscreen event is determined without receiving any user input from a touchscreen device; and generate the touchscreen event for processing by an application executing on the computing device, wherein the application is designed to process touchscreen events initiated by touchscreen devices.

In one example, a method includes receiving, via a trackpad device coupled to a computing device, touch-based input comprising one or more gestures, wherein the trackpad device is physically distinct from a display device coupled to the computing device. The method further includes determining, by the computing device, a trackpad operation based upon the touch-based input, and determining, by the computing device, a touchscreen event based upon a mapping of the trackpad operation to the touchscreen event, wherein the touchscreen event is determined without receiving any user input from a touchscreen device. The method further includes generating, by the computing device, the touchscreen event for processing by an application executing on the computing device, wherein the application is designed to process touchscreen events initiated by touchscreen devices.

In one example, a computing device includes one or more processors, a trackpad driver, and an application. The trackpad driver is operable by the one or more processors to receive, via a trackpad device coupled to the computing device, touch-based input comprising one or more gestures, wherein the trackpad device is physically distinct from a display device that is also coupled to the computing device. The application is also operable by the one or more processors, the application being designed to process touchscreen events initiated by touchscreen devices. The computing device further includes means for determining a touchscreen event based upon a mapping from a trackpad operation that is based upon the touch-based input, wherein the touchscreen event is determined without receiving any user input from a touchscreen device. The computing device further includes means for generating the touchscreen event for processing by the application.

The details of one or more aspects of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example of a computing device that may be configured to determine touchscreen events based upon trackpad operations, in accordance with one or more aspects of the present disclosure.

FIG. 2 is a block diagram illustrating further details of one example of the computing device shown in FIG. 1.

FIG. 3 is a flow diagram illustrating an example method that may be performed by a computing device to determine a touchscreen event based upon a trackpad operation, in accordance with one or more aspects of the present disclosure.

FIG. 4 is a diagram illustrating example trackpad operations that may be mapped to corresponding touchscreen events.

FIG. 5 is a conceptual diagram illustrating an example mapping of a trackpad tap operation to a touchscreen tap event at a current location of a pointer that may be displayed via a display device.

FIG. 6 is a conceptual diagram illustrating an example mapping of a trackpad multi-touch movement operation to a touchscreen single-touch event.

FIG. 7 is a screen diagram illustrating an example of movement of content that is displayed via a display device in a downward fashion.

FIG. 8 is a conceptual diagram illustrating an example mapping of a trackpad multi-touch movement operation to a touchscreen multi-touch event.

FIG. 9 is a conceptual diagram illustrating an example of a trackpad single-touch movement operation that may cause movement of a pointer that is displayed via a display device.

### DETAILED DESCRIPTION

Techniques of the present disclosure may allow a computing device (e.g., a mobile/portable device) to transform or map trackpad operations to corresponding touchscreen events, where the computing device may or may not include a touchscreen interface/device but at least includes, or is coupled to, a trackpad device. Certain applications and operating systems (e.g., the Android® operating system) have been designed around a touchscreen user interface, but it may be beneficial to allow such applications and operating systems to be implemented on more traditional devices (e.g., desktop/netbook/laptop devices) that include physical keyboards and/or pointing devices, such as trackpad devices. Trackpad operations may be directly mapped to touchscreen events, which may be processed by applications that may be configured to process such events. In such fashion, a computing device may be capable of processing touchscreen-based events for applications that are configured to process such events during execution on the computing device, regardless of whether the computing device includes or is coupled to a touchscreen.

For instance, a user may initially move a single finger on the trackpad device to cause a displayed pointer to move correspondingly on a display device of the computing device. The user may touch or tap a single finger on the trackpad device to deliver a simulated touchscreen finger tap at the current pointer location as displayed on the display device. The trackpad finger tap operation may thereby be mapped to a touchscreen finger tap event that may be generated for processing by an application that is designed to receive input via a touchscreen interface.

If the user touches two fingers on the trackpad device and substantially moves them together, those movements can be mapped into absolute touchscreen events relative to the current pointer location displayed at the start of movement, allowing the user to directly interact with graphical elements located at the current pointer location as if they are using a touchscreen device, and perform traditional touchscreen operations (e.g., dragging/flinging content, scrolling). There may also be a mechanism to map multi-touch operations from the trackpad device to select certain touchscreen events, such as pinch-zoom events. The computing device may, for example, generate such touchscreen events upon determining that the user's two fingers are moving in different directions on the trackpad device, or even possibly by determining that the user is holding down a modifier on the physical keyboard while moving the two fingers on the trackpad device. In such fashion, the track pad can function as a “virtual” touchscreen input device.

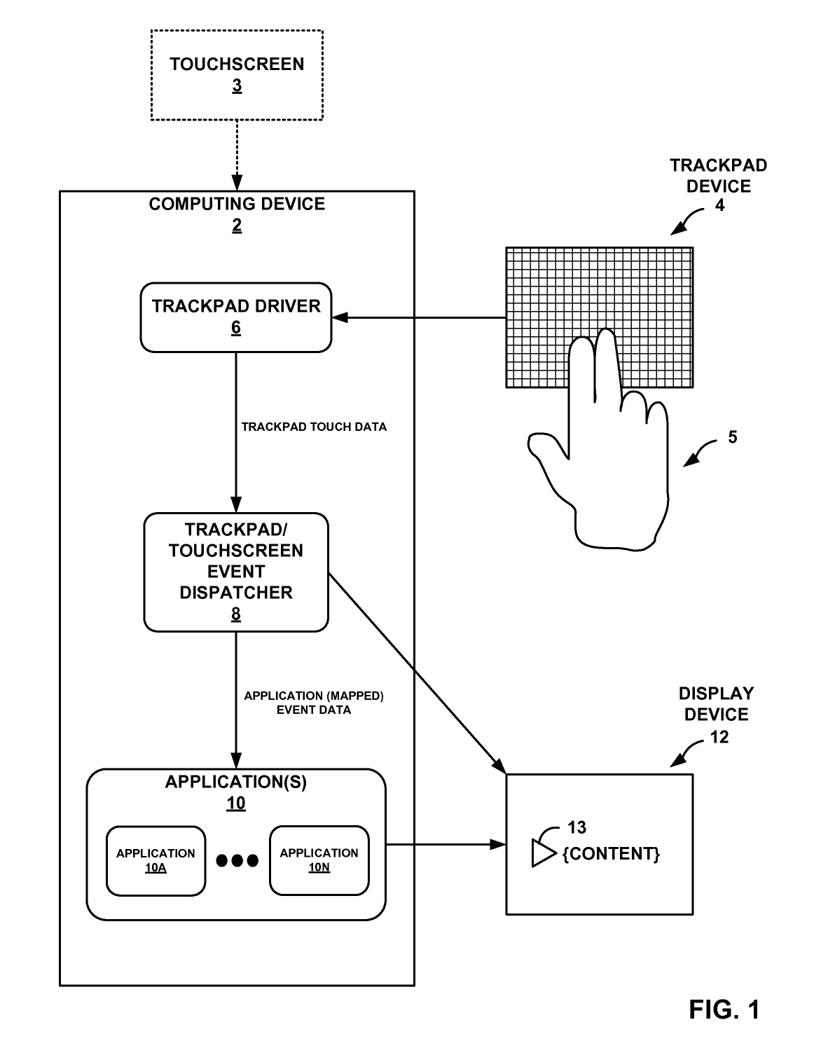

FIG. 1 is a block diagram illustrating an example of a computing device 2 that may be configured to map trackpad operations to corresponding touchscreen events, in accordance with one or more aspects of the present disclosure. Computing device 2 may, in some examples, comprise or be part of a desktop computing device or a mobile/portable computing device (e.g., netbook/laptop/tablet device). Computing device 2 may include or be otherwise coupled to a trackpad device 4 and a display device 12. Display device 12 may be capable of displaying a pointer 13 and various content. In the example of FIG. 1, computing device 2 may or may not include, or be otherwise coupled to, a separate, optional touchscreen device or touchscreen interface 3. Trackpad device 4 may be physically distinct from display device 12.

Computing device 2 may be capable of executing one or more applications 10A-10N (collectively, applications 10). Applications 10 may include any number of applications that may be executed by computing device 2, such as a digital multimedia player application, a video game application, a web browser application, an email application, a word processing application, a spreadsheet application, and/or a document reader application, to name only a few. Applications 10 may execute on computing device 2 via an operating system that is also executed by computing device 2. This operating system and/or one or more of applications 10 may be designed around a touchscreen user interface, or be configured to process touchscreen events, even though computing device 2 may or not include/be coupled to touchscreen 3.

As shown in FIG. 1, computing device 2 includes or is otherwise coupled to trackpad device 4. In some examples, trackpad device 4 may be external to computing device 2. A user may provide user input to computing device 2 via trackpad device 4. For instance, a user may use one or more fingers of his/her hand 5 to provide user input via trackpad device 4. In the example shown in FIG. 1, the user has placed two fingers of hand 5 onto the surface of trackpad device 4 to provide multi-touch input. Of course, the user may provide any form of single- or multi-touch gesture input via trackpad device 4. In addition, in other examples, the user may utilize another input means, such as a stylus, to provide input via trackpad device 4.

Computing device 2 includes trackpad driver 6, which manages the operational interface to trackpad device 4. Trackpad driver 6 may comprise one or more software/firmware modules, in some examples, that manage this interface. In some cases, trackpad driver 6 may include software that is executed as part of the operating system of computing device 2. Computing device 2 also includes a trackpad/touchscreen event dispatcher 8 that may be implemented or executed by computing device. In some cases, trackpad/touchscreen event dispatcher 8 may include software that is executed as part of the operating system of computing device 2.

The user input (e.g., single- and/or multi-touch gesture input) received via trackpad device 4 may be processed or determined by trackpad driver 6, and trackpad driver 6 may provide trackpad touch data corresponding to the received user input, which may comprise touch-based input (e.g., multi-touch input). This trackpad touch data may, in some cases, include raw touch data.

Trackpad driver 6 and/or trackpad/touchscreen event dispatcher 8 may determine trackpad operations (e.g., multi-touch movement operations) based upon the touch-based user input. For example, trackpad driver and/or trackpad/touchscreen event dispatcher 8 may determine, based upon user input received via trackpad device 4, that the user has initiated tap, other single-touch, and/or multi-touch gestures.

Trackpad/touchscreen event dispatcher 8 may determine corresponding touchscreen events based upon mappings of the trackpad operations to these touchscreen events, wherein the touchscreen events are determined without receiving any user input from a touchscreen device. Trackpad/touchscreen event dispatcher 8 may then generate touchscreen events for processing by one or more of applications 10 that are designed to process touchscreen events initiated by touchscreen devices. These one or more of applications 10 and/or trackpad/touchscreen event dispatcher 8 may update the display of information displayed via display device 12, such as the content displayed via display device 12 at a current location of pointer 13 that is also displayed via display device 12. As shown in FIG. 1, trackpad/touchscreen event dispatcher 8 may provide application (included mapped) touch data to one or more of applications 10 for processing.

For instance, trackpad/touchscreen event dispatcher 8 may map a trackpad tap operation into a touchscreen tap operation that is generated at the current location of pointer 13 that is displayed via display device 12. In some examples, a user may move two fingers (i.e., digits) of hand 5 from a first location to a second location on the surface of trackpad device 4. In these examples, trackpad/touchscreen event dispatcher 8 may map such a trackpad multi-touch movement operation from the first location to the second location into a touchscreen event (e.g., touchscreen single-touch event) comprising movement from the first location to the second location relative to the current location of pointer 13 at the start of movement. In this example, a multi-touch trackpad operation may be mapped into a single-touch touchscreen event processed by one or more of applications 10 relative to the current location of pointer 13. For example, the single-touch touchscreen event may be processed by one of applications 10 to perform certain actions or instructions, such as dragging or scrolling content that is displayed at the location of pointer 13. Numerous other examples of trackpad operation to touchscreen event mapping will be provided below.

In some cases, the user may interact with trackpad device 4 to cause movement of pointer 13 that is displayed via display device 12. For instance, in some cases, the use may move one finger of hand 5 on the surface of trackpad device 4 to cause movement of pointer 13. The single-touch input via trackpad device 4 may not necessarily be translated or mapped into a corresponding touchscreen event, but may be utilized to move pointer 13. Subsequent touchscreen events that are mapped from trackpad operations may be processed by one or more of applications 10 respective to the current location of pointer 13.

Certain aspects of the disclosure may provide one or more benefits. For example, certain aspects may allow computing device 2 to transform or map trackpad operations to corresponding touchscreen events, where computing device 2 includes, or is coupled to, trackpad device 4. Computing device 2 may implement or execute certain applications and operating systems (e.g., the Android® operating system) that have been designed around a touchscreen user interface, even though computing device 2 may or may not be coupled to optional touchscreen 3.

Trackpad operations may be directly mapped to touchscreen events, which may be processed by applications (e.g., one or more of applications 10) that may be configured to process such events. In such fashion, computing device 2, which may or may not include/be coupled to touchscreen device 3, may still be capable of processing touchscreen-based events for applications that are configured to process such events during execution on computing device 2 based upon input provided to trackpad device 4.

As indicated in FIG. 1, computing device 2 may or may not include, or be coupled to, separate touchscreen interface device 3, which is an optional component. In examples where computing device 2 does include, or is coupled to, touchscreen 3, touchscreen 3 may provide a separate input mechanism for obtaining touch-based (e.g., multi-touch) input. The input of touchscreen 3 may be processed by a touchscreen driver included in computing device 2 (not shown in FIG. 1), which may then provide touchscreen data to an event processing mechanism, which provides touchscreen events to applications 10. In some cases, this event processing mechanism may be included within a separate functional module in event dispatcher 8. This separate module may process touchscreen data provided by the touchscreen driver and generate separate touchscreen events for processing by applications 10.

However, in examples where computing device 2 is coupled to, or does include, touchscreen 3, a user need not necessarily use touchscreen 3 in order to cause computing device 2 to generate touchscreen events for processing by applications 10. Instead, the user may interact with trackpad device 4 to cause trackpad driver 6 to provide trackpad touch data to event dispatcher 8, which maps one or more trackpad operations to touchscreen events, as described above, and provides such touchscreen events for processing by applications 10.

For instance, in one specific example, computing device 2 may comprise a tablet computer that includes a touchscreen interface. However, the tablet computing can be docked with a separate keyboard, which may include a trackpad device (e.g., trackpad 4). When the tablet computer is docked, the user can interact with the trackpad device without needing to reach over to and use the touchscreen. In such fashion, the user need not use the touchscreen of the tablet computing, but can rather interact with the separate trackpad device to cause the tablet to generate and process touchscreen events, just as though the user were using the touchscreen. The trackpad device may thereby serve as a “virtual” touchscreen input device.

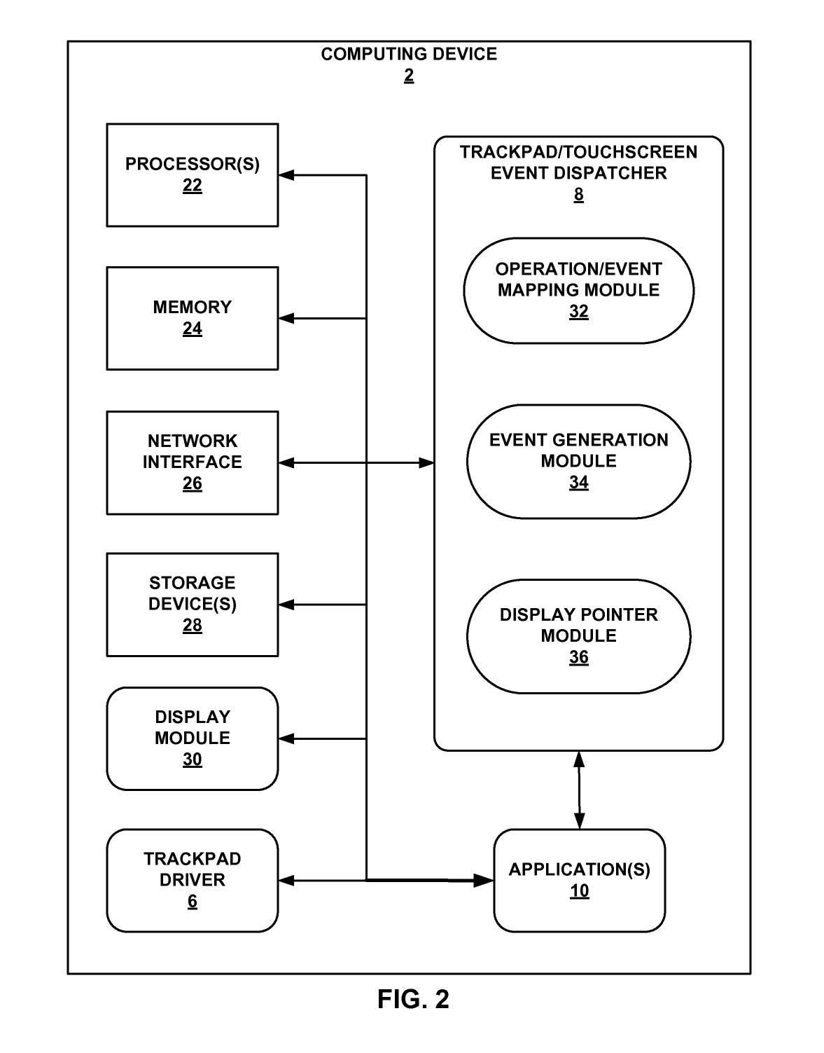

FIG. 2 is a block diagram illustrating further details of one example of computing device 2 shown in FIG. 1. FIG. 2 illustrates only one particular example of computing device 2, and many other example embodiments of computing device 2 may be used in other instances.

As shown in the specific example of FIG. 2, computing device 2 includes one or more processors 22, memory 24, a network interface 26, and one or more storage devices 28. Computing device 2 also includes a display module 30 and trackpad driver 6, which may comprise modules that are executable by computing device 2. Applications 10 are also executable by computing device 2. Each of components 22, 24, 26, 28, 30, 6, and 10 may be interconnected (physically, communicatively, and/or operatively) for inter-component communications. Although not shown in FIG. 2, computing device 2 may also include, or be coupled to, one or more input devices to enable a user to input data, such as a keyboard, mouse, trackpad (e.g., trackpad device 4 shown in FIG. 1), microphone, etc. Computing device may further include, or be coupled to, one or more output devices, such as a display (e.g., display device 12 shown in FIG. 1), a printer, and/or one or more speakers.

Processors 22 may be configured to implement functionality and/or process instructions for execution within computing device 2. Processors 22 may be capable of processing instructions stored in memory 24 or instructions stored on storage devices 28.

Memory 24 may be configured to store information within computing device 2 during operation. Memory 24 may, in some examples, be described as a computer-readable storage medium. In some examples, memory 24 is a temporary memory, meaning that a primary purpose of memory 24 is not long-term storage. Memory 24 may also, in some examples, be described as a volatile memory, meaning that memory 24 does not maintain stored contents when the computer is turned off. Examples of volatile memories include random access memories (RAM), dynamic random access memories (DRAM), static random access memories (SRAM), and other forms of volatile memories known in the art. In some examples, memory 24 may be used to store program instructions for execution by processors 22. Memory 24 may be used by software or applications running on computing device 2 (e.g., one or more of applications 10) to temporarily store information during program execution.

Storage devices 28 may also include one or more computer-readable storage media. Storage devices 28 may be configured to store larger amounts of information than memory 24. Storage devices 28 may further be configured for long-term storage of information. In some examples, storage devices 28 may comprise non-volatile storage elements. Examples of such non-volatile storage elements may include magnetic hard discs, optical discs, floppy discs, flash memories, or forms of electrically programmable memories (EPROM) or electrically erasable and programmable (EEPROM) memories.

Computing device 2 also includes network interface 26. Computing device 2 may utilize network interface 26 to communicate with external devices via one or more networks, such as one or more wireless networks. In some examples, network interface 26 may include a Bluetooth® network interface module. In these examples, computing device 2 may utilize network interface 26 to wirelessly communicate with external device 4 via Bluetooth® communication. Display module 30 is operable to provide an interface to a display device (e.g., display device 12 shown in FIG. 1). For instance, display module 30 may manage the display data that is displayed, or that is to be displayed, via display device 12.

Any applications implemented within or executed by computing device 2 (e.g., applications 10) may be implemented or contained within, operable by, executed by, and/or be operatively/communicatively coupled to processors 22, memory 24, network interface 26, and/or storage devices 28.

As shown in the example of FIG. 2, computing device 2 may further include trackpad/touchscreen event dispatcher 8. Trackpad/touchscreen event dispatcher 8 may be implemented or executed by computing device 2 as one or more software modules, hardware modules, firmware modules, or any combination thereof. For instance, in some examples, one or more of modules of trackpad/touchscreen event dispatcher 8 may be stored in memory 24 and/or storage devices 28, and loaded for execution by processors 22. In some examples, one or more of these modules may be implemented directly by processors 22.

Example modules 32, 34, and 36 of trackpad/touchscreen event dispatcher 8 are shown in FIG. 2. Operation/event mapping module 32 may be operable to map trackpad operations to touchscreen events. Event generation module 34 may be operable to generate one or more events, such as touchscreen events, that may be processed by one or more of applications 10. Display pointer module 36 may be operable to control the display of a pointer (e.g., the type and/or current location of a pointer, such as pointer 13 shown in FIG. 1) via a display device. Modules 32, 34, and 36 will be described in further detail below.

Trackpad driver 6 may be operable by processors 22 to receive, via trackpad device 4, touch-based input comprising one or more gestures. One or more of applications 10, operable by processors 22, may be designed to process touchscreen events initiated by touchscreen devices, even though computing device may not include or be otherwise coupled to a touchscreen device. Operation/event mapping module 32 may be operable by processors 22 to perform the mapping of a given trackpad operation to a touchscreen event at least by receiving trackpad touch data corresponding to the touch-based input that is provided by trackpad driver 6.

Event generation module 34 may be operable by processors 22 to generate the touchscreen event at least by providing mapped touch data corresponding to the touchscreen event to an application (e.g., one of applications 10, such as application 10A). Display module 30 may be operable by processors 22 to update content displayed via the display device (e.g., display device 12) based upon the processing of the touchscreen event by application 10A. Display module 30 may, in some cases, receive display information from trackpad/touchscreen event dispatcher (e.g., from display pointer module 36) and/or the application 10A.

Display pointer module 36 may be operable by processors 22 to determine a current location of pointer 13 that is displayed via display device 12. Event generation module 34 may be operable to generate the touchscreen event for processing by application 10A at the current location determined by display pointer module 36. In some cases, display pointer module 36 is further operable to update the current location of pointer 13 that is displayed via display device 12 based upon a second trackpad operation that corresponds to movement via trackpad device 4 based upon additional touch-based input. For instance, a user may initiate a single-touch gesture via trackpad device 4 to cause movement of pointer 13.

In one example, the trackpad operation may comprise a trackpad tap operation, where the user touches or taps a finger of hand 5 (FIG. 1) on the surface of trackpad device 4 at a particular location, and then lifts or removes the finger from the surface to release contact from trackpad device 4. In this example, operation/event mapping module 32 is operable to determine a touchscreen tap event at the current location of pointer 13. Event generation module 34 may generate this touchscreen tap event for processing by application 4A.

In some cases, trackpad/touchscreen event dispatcher 8 may provide touchscreen event data to any of applications 10, including application 10A, via an asynchronous event handling interface. In the example above, trackpad/touchscreen event dispatcher 8 may provide the touchscreen tap event data to application 10A via such an interface, and may also further provide location information for the current/present location of pointer 13, such that the event may be processed by application 10A with respect to this location. The event data may be provided by event generation module 34, and the pointer location information may be provided by display pointer module 36.

In one example, the trackpad operation may comprise a trackpad multi-touch movement operation from a first location to a second location based upon the touch-based input via trackpad device 4. The touch-based input may comprise movement via trackpad device 4 of at least two user digits of hand 5 from the first location to the second location. Operation/event mapping module 32 may be operable to determine, based upon a mapping from the trackpad operation, a touchscreen single-touch event comprising movement from the first location to the second location relative to the current location of pointer 13 at the start of movement, according to this specific example. Thus, in this example, a multi-touch trackpad gesture received via trackpad device 4, where at least two of the user's fingers are moving substantially together across trackpad device 4, may be mapped to a single-touch touchscreen gesture event (e.g., simulating one finger/digit down on a touchscreen) that may be processed by application 10A.

In another example, the trackpad operation may comprise a trackpad multi-touch movement operation in multiple directions based upon the touch-based input, where the touch-based input comprising movement via trackpad device 4 of at least two user digits in the multiple directions. Operation/event mapping module 32 may be operable to determine, based upon a mapping from the trackpad operation, a touchscreen multi-touch event comprising movement in the multiple directions relative to the current location of pointer 13 at the start of movement. Thus, in this example, a multi-touch trackpad gesture received via trackpad device 4, where at least two of the user's fingers are moving in different directions across trackpad device 4, may be mapped to a multi-touch touchscreen gesture event (e.g., simulating two fingers/digits down on a touchscreen) that may be processed by application 10A (e.g., for operations such as pinch zoom).

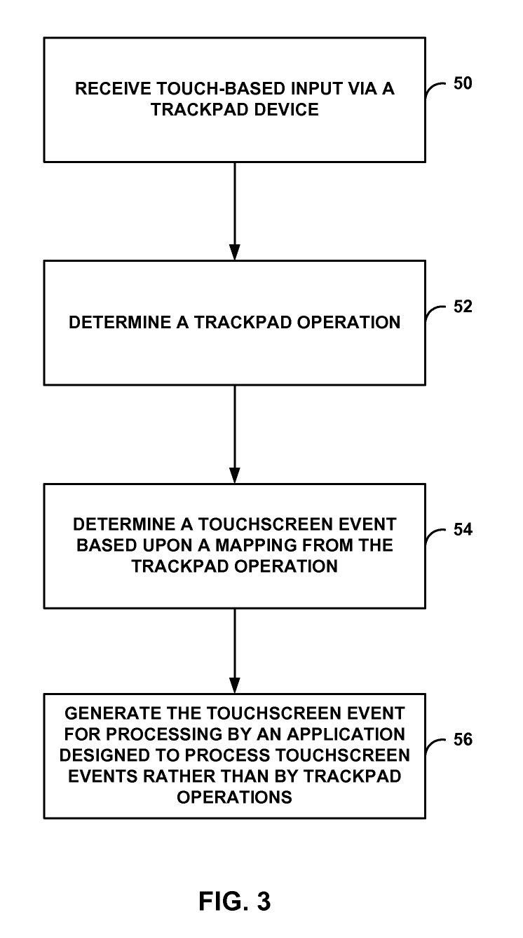

FIG. 3 is a flow diagram illustrating an example method that may be performed by a computing device to map trackpad operations to touchscreen events, in accordance with one or more aspects of the present disclosure. For example, the method illustrated in FIG. 3 may be performed by computing device 2 shown in FIGS. 1 and/or 2, where the computing device may or may not be coupled to any touchscreen device.

The method includes receiving, via a trackpad device coupled to a computing device, touch-based input comprising one or more gestures, wherein the trackpad device is physically distinct from a display device coupled to the computing device (50). The method further includes determining, by the computing device, a trackpad operation based upon the touch-based input (52), and determining, by the computing device, a touchscreen event based upon a mapping of the trackpad operation to the touchscreen event, wherein the touchscreen event is determined without receiving any user input from a touchscreen device (54). The method also includes generating, by the computing device, the touchscreen event for processing by an application executing on the computing device, wherein the application is designed to process touchscreen events initiated by touchscreen devices (56). In some cases, the computing device may be further coupled to a separate touchscreen device.

The touch-based input may comprise multi-touch input, and the trackpad operation may include a multi-touch movement operation. In some examples, determining the touchscreen event may include receiving trackpad touch data corresponding to the touch-based input that is provided by a trackpad driver associated with the trackpad device, and generating the touchscreen event may include providing mapped touch data corresponding to the touchscreen event to the application.

The method of FIG. 3 may further include updating content displayed via the display device based upon the processing of the touchscreen event by the application. In some examples, the method may further include determining a current location of a pointer that is displayed via the display device, wherein generating the touchscreen event includes generating the touchscreen event for processing by the application at the current location of the pointer. The method may also further include updating the current location of the pointer that is displayed via the display device based upon a second trackpad operation that corresponds to movement via the trackpad device based upon additional touch-based input.

In some examples, the trackpad operation may include a trackpad tap operation, and determining the touchscreen event may include determining a touchscreen tap event at the current location of the pointer. In some examples, the touch-based input may comprise movement via the trackpad device of at least two user digits from a first location to a second location, the trackpad operation may include a trackpad multi-touch movement operation from the first location to the second location based upon the touch-based input, and determining the touchscreen event may include determining a touchscreen single-touch event comprising movement from the first location to the second location relative to the current location of the pointer.

In some examples, the trackpad operation may include a trackpad multi-touch movement operation in multiple directions based upon the touch-based input, where the touch-based input comprises movement via the trackpad device of at least two user digits in the multiple directions. Determining the touchscreen event may include determining a touchscreen multi-touch event comprising movement in the multiple directions relative to the current location of the pointer.

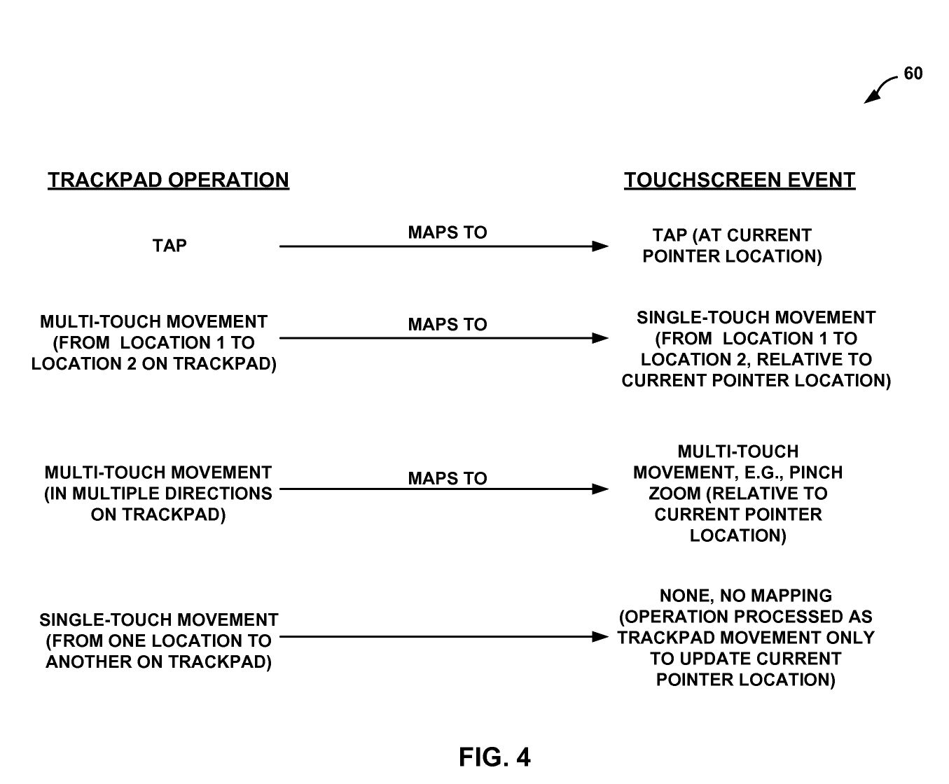

FIG. 4 is a diagram illustrating example trackpad operations that may be mapped to corresponding touchscreen events. The mapping of trackpad operations to touchscreen events may be performed by operation/event mapping module 32 of trackpad/touchscreen event dispatcher 8 (FIG. 2), according to some aspects. The touchscreen events shown in FIG. 4 may be generated by event generation module 34, according to some examples.

As shown in FIG. 4, the mapping of trackpad operations to touchscreen events may be captured in a table 60. Table 60 may be utilized by operation/event mapping module 32, and may be stored in memory 24. In some cases, table 60 may also be stored in storage devices 28. The information of table 60 may be pre-configured within computing device 2. In some cases, however, the information of table 60 may be user- or system-modifiable (e.g., by an administrator of computing device 2).

The mappings shown in FIG. 4 are presented for purposes of illustration only. Various other or additional mappings are also fully contemplated within the scope of this disclosure. The trackpad operations that are shown may be determined based upon trackpad touch data that is received from trackpad driver 6, or may, in some cases, be received from trackpad driver 6.

The first trackpad operation shown in FIG. 4 is a trackpad tap operation, which corresponds to a user's tap at a particular location on trackpad 4. The tap gesture may comprise a touching and release of contact from the surface of trackpad 4. Mapping module 32 may map this trackpad operation to a touchscreen tap event at a current pointer location of pointer 13 that is displayed via display device 12. The current pointer location of pointer 13 may be monitored and/or managed by display pointer module 36. Event generation module 34 may generate this event for processing by one or more of applications 10, and may provide the event data corresponding to this event to the one or more of applications 10, which may include current location data for pointer 13.

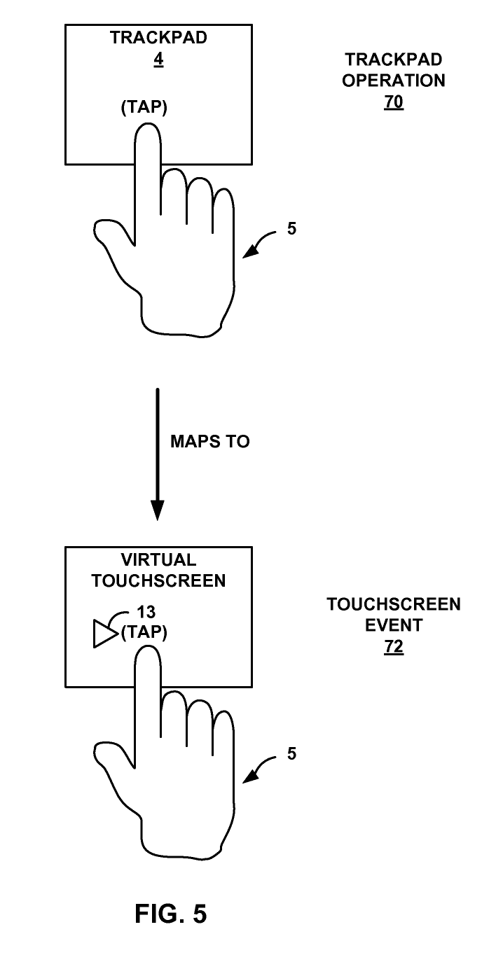

As one example, FIG. 5 is a conceptual diagram illustrating an example mapping of a trackpad tap operation to a touchscreen tap event at a current location of pointer 13. In FIG. 5, trackpad operation 70 corresponds to a trackpad tap operation based upon a user tapping a finger of hand 5 via trackpad 4. This trackpad operation 70 is mapped, by mapping module 32, to touchscreen event 72, which comprises a touchscreen tap event. This touchscreen event 72 comprises an event that is generated by event generation module 34 via receipt of a tap gesture from a user's finger of hand 5 on trackpad 4, even though trackpad 4 does not comprise a touchscreen device. Thus, trackpad 4 may function as a virtual touchscreen input device, in which trackpad tap operation 70 may be mapped to touchscreen tap event 72. Display device 12 (not shown in FIG. 5) may serve as the output device, such that trackpad 4 and display device 12 in combination may function as a virtual touchscreen device, as shown in FIG. 5.

In such fashion, touchscreen tap event 72 may be generated for processing by one or more of applications 10 without the use of an actual touchscreen device. In this case, trackpad 4 functions as a virtual touchscreen input device. In some examples, touchscreen tap event 72 may cause selection of item presented for display at a current location of pointer 13 by one or more of applications 10. For example, if pointer 13 is displayed by, with, or over an icon or other graphical item, the generation of touchscreen tap event 72 may cause selection of this icon or other graphical item during execution of the one or more of applications 10.

Referring again to FIG. 4, a second trackpad operation may comprise a multi-touch movement gesture from a first location to a second location on trackpad 4. Mapping module 32 may map this trackpad operation to a touchscreen single-touch gesture event corresponding to movement from the first location to the second location relative to the current pointer location of pointer 13. The trackpad multi-touch gesture may comprise an initiation of contact with multiple fingers of hand 5 and movement of the fingers substantially together, in a given direction, from the first location to the second location on trackpad 4 while maintaining contact with trackpad 4.

Mapping module 32 may map this trackpad operation to a touchscreen single-touch gesture event corresponding to movement from the first location to the second location relative the position of pointer 13. The current pointer location of pointer 13 may be monitored and/or managed by display pointer module 36 (FIG. 2). Event generation module 34 may generate the event for processing by one or more of applications 10, and may provide the touch data corresponding to this event to the one or more of applications 10. This touch data may include current location data for pointer 13 and the movement/position information corresponding to the first and second locations.

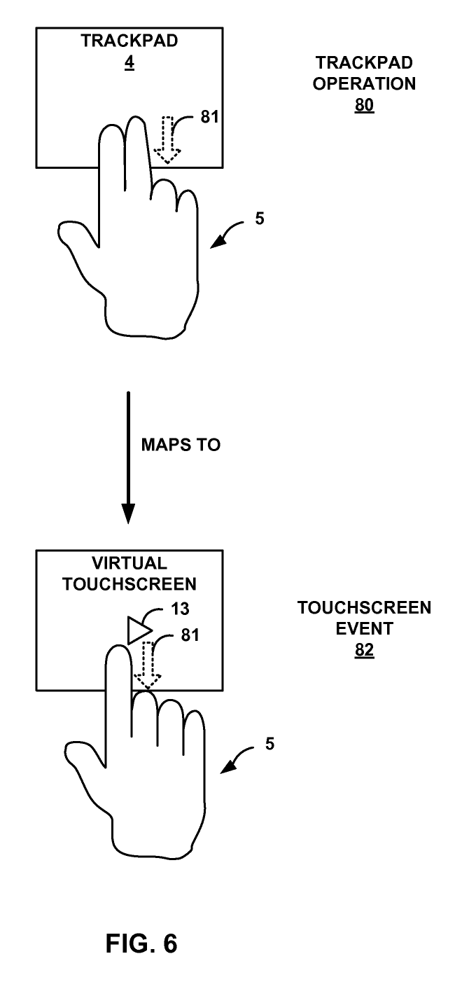

As one example, FIG. 6 is a conceptual diagram illustrating an example mapping of a trackpad multi-touch movement operation to a touchscreen single-touch gesture event. In FIG. 6, trackpad operation 80 corresponds to a trackpad multi-touch operation based upon a user moving multiple fingers of hand 5 substantially together, via trackpad 4, in a downward direction 81 from a first location to a second location. This trackpad operation 80 is mapped, by mapping module 32, to touchscreen event 82, which comprises a single-touch touchscreen gesture movement event (e.g., single finger down on a virtual touchscreen input device) in downward direction 81 from the first location to the second location relative to the current position of pointer 13 displayed on display device 12 at the start of movement.

Thus, trackpad 4 may function as a virtual touchscreen input device, in which trackpad multi-touch operation 80 may be mapped to touchscreen single-touch gesture event 82. As shown in FIG. 6, the generation of touchscreen single-touch event 82 may create the virtual effect of a single finger of user's hand 5 moving across a virtual touchscreen input device, in downward direction 81, from the first location to the second location with respect to a current location of pointer 13 displayed via display device 12. Although the user is actually using multiple fingers of hand 5 to move across the surface of trackpad 4 from the first location to the second location in downward direction 81, the mapping of trackpad operation 80 to touchscreen event 82 may cause one or more of applications 10 to process touchscreen event 82 as though trackpad 4 represented a touchscreen input device, and where the user has initiated a single-touch gesture movement in downward direction 81, via hand 5, across the surface of this virtual touchscreen input device.

This touchscreen event 82 comprises an event that is generated by event generation module 34 upon processing of trackpad multi-touch operation 80, even though trackpad 4 does not comprise an actual touchscreen device, but instead functions a virtual touchscreen input mechanism. In such fashion, a touchscreen single-touch gesture event may be generated for processing by one or more of applications 10 without the use of an actual touchscreen device. For instance, the generated touchscreen single-touch gesture event 82 may cause one or more of applications 10 to perform certain actions or execute corresponding instructions, such as, for instance, dragging or scrolling content that may be presently displayed at the current location of pointer 13 on display device 12, just as would be the case if display device 12 were a touchscreen display device.

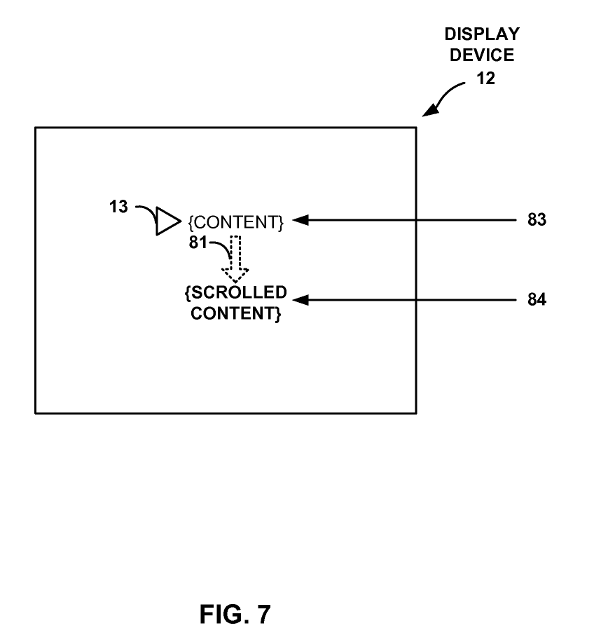

FIG. 7 is a screen diagram illustrating an example of movement of content that is displayed via display device 12 in a downward fashion. In the example of FIG. 6, trackpad operation 80 corresponds to a multi-touch gesture of hand 5 in downward direction 81, which becomes mapped to touchscreen event 82 that corresponds to a single-touch gesture in downward direction 81. When touchscreen event 82 is processed by one or more of applications 10, such as application 10A, touchscreen event 82 may cause certain actions to be performed, or instructions to be executed, by application 10A with respect to content displayed by, with, or beneath pointer 13 that is displayed via display device 12.

As shown in the example scenario of FIG. 7, which is simply one non-limiting example shown for purposes of illustration only, pointer 13, which is displayed via display device 12, has a current displayed location that is on or adjacent to the indicated content. This content may initially be positioned at location 83 when displayed via display device 12. Application 10A, during execution, may present this content for display via display device 12.

Upon receipt and processing of touchscreen event 82 shown in FIG. 6, corresponding to a touchscreen single-touch gesture event corresponding to movement in downward direction 81 from a first location to a second location, application 10A may cause the scrolling or movement of the displayed content in downward direction 81 from the first location to the second location indicated by touchscreen event 82, with respect to the current position of pointer 13. Thus, as is shown in FIG. 7, the displayed content is scrolled in downward direction 81 from location 83 to location 84, which may correspond to the first and second locations associated with touchscreen event 82 relative to the current location of pointer 13, as shown in FIG. 7.

Thus, in this example, the processing of touchscreen single-touch movement gesture 82, for downward direction 81, causes the content shown in FIG. 7 to be scrolled in downward direction 81 when displayed via display device 12, similar to the manner in which content would be scrolled if displayed on an actual touchscreen device upon receipt of a single-touch movement gesture in downward direction 81. In the example of FIG. 7, the location of pointer 13 may stay fixed, even though the content may scroll from location 83 to location 84. In other examples, the location of pointer 13 may also be scrolled in a downward direction, such that it is displayed by, with, or above the scrolled content at location 84 on display 12.

Referring again to FIG. 4, a third trackpad operation may comprise a multi-touch movement gesture in multiple different directions on trackpad 4. Mapping module 32 may map this trackpad operation to a touchscreen multi-touch gesture movement event (e.g., pinch zoom) corresponding movement in the different directions relative to the current pointer location of pointer 13 displayed via display device 12. The trackpad multi-touch gesture may comprise an initiation of contact with multiple fingers of hand 5 and movement of the fingers substantially in multiple different directions on trackpad 4 while maintaining contact with trackpad 4.

Mapping module 32 may map this trackpad operation to a touchscreen multi-touch gesture event corresponding to movement in these different directions relative the position of pointer 13. The current pointer location of pointer 13 may be monitored and/or managed by display pointer module 36 (FIG. 2). Event generation module 34 may generate the event for processing by one or more of applications 10, and may provide the touch data corresponding to this event to the one or more of applications 10. This touch data may include current location data for pointer 13 and the movement/position information corresponding to multi-touch movement in the different directions.

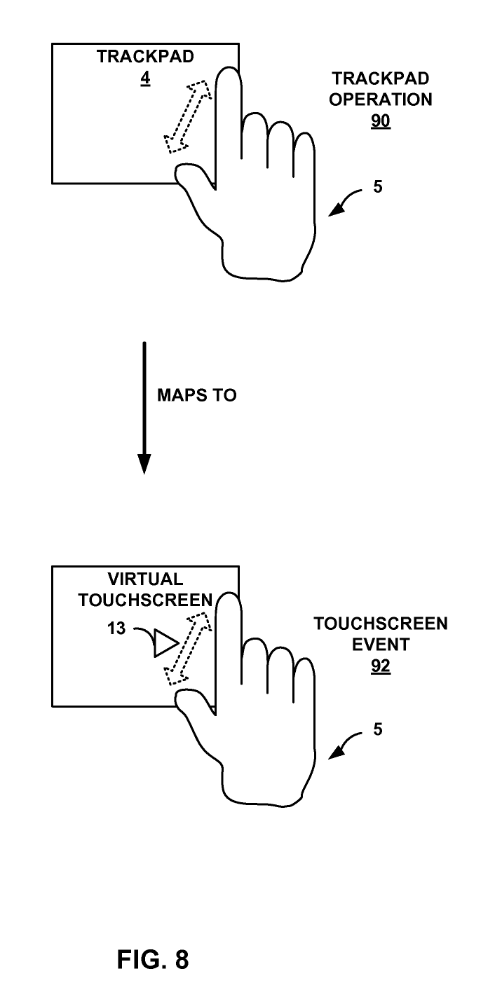

As one example, FIG. 8 is a conceptual diagram illustrating an example mapping of a trackpad multi-touch movement operation to a touchscreen multi-touch gesture event. In FIG. 8, trackpad operation 90 corresponds to a trackpad multi-touch operation based upon a user moving multiple fingers of hand 5 substantially in different directions across trackpad 4. As shown in this example, the user may move the thumb and index fingers of hand 5 in different directions across trackpad 4. This trackpad operation 90 is mapped, by mapping module 32, to touchscreen event 92, which comprises a multi-touch touchscreen gesture movement event (e.g., multiple fingers down on a virtual touchscreen input device) for movement in different directions relative to the current position of pointer 13.

Thus, trackpad 4 may function as a virtual touchscreen input device, in which trackpad multi-touch operation 90 may be mapped to touchscreen multi-touch gesture event 2. As shown in FIG. 8, the generation of touchscreen multi-touch event 92 may create the virtual effect of multiple fingers of user's hand 5 moving across a virtual touchscreen input device in multiple directions with respect to a current location of pointer 13 displayed via display device 12. The mapping of trackpad operation 90 to touchscreen event 92 may cause one or more of applications 10 to process touchscreen event 92 as though trackpad 4 represented a touchscreen input device, and where the user has initiated a multi-touch gesture in multiple different directions across the surface of this virtual touchscreen input device.

This touchscreen event 92 comprises an event that is generated by event generation module 34 upon processing of trackpad multi-touch operation 90, where trackpad 4 functions a virtual touchscreen input mechanism. In such fashion, a touchscreen multi-touch gesture event may be generated for processing by one or more of applications 10 without the use of an actual touchscreen device. For instance, the generated touchscreen multi-touch gesture event 92 may cause one or more of applications 10 to pinch zoom content that may be presently displayed at the current location of pointer 13 on display device 12, just as would be the case if display device 12 were a touchscreen display device.

In the example of FIG. 8 where the two fingers of hand 5 are moving apart in different directions, the generated touchscreen multi-touch event 92 may cause one or more of applications 10 to perform a zoom-in operation with respect to content that is displayed by, with, or beneath pointer 13 on display device 12. In another example, where two fingers of hand 5 may be moving together in different directions, the generated touchscreen multi-touch event may instead cause one or more of applications 10 to perform a zoom-out operation with respect to content that is displayed by, with, or beneath pointer 13.

In some cases, mapping module 32 may map trackpad operation 90 to touchscreen event 92 based upon trackpad touch data that is received from trackpad driver 6 (FIG. 1), which is generated based upon interaction of hand 5 with trackpad 4. Mapping module 32 may determine to select touchscreen event 92 based upon the touch data received from trackpad driver 6 indicating multi-touch movement in different directions across trackpad 4.

In some instances, when initiating multi-touch gestures comprising movement in different directions across trackpad 4, the user may also optionally select another input mechanism, such as a key on a keyboard that is part of or coupled to computing device 2, when performing multi-touch gestures of movement in these different directions via trackpad 4. In these instances, the data associated with such a selection may be provided (e.g., by a keyboard driver) to mapping module 32. Mapping module 32 may utilize this data in conjunction with the touch data provided by trackpad driver 6 when determining the event (e.g., touchscreen event 92) that is to be generated. For example, the data associated with a keyboard key selection may trigger mapping module 32 to determine that touchscreen multi-touch event 92 is to be generated by event generation module 34.

Referring again to FIG. 4, a fourth trackpad operation may comprise a single-touch movement gesture from one location to another via trackpad 4. The trackpad single-touch gesture may comprise an initiation of contact with one finger of hand 5 and movement of the finger from one location to another via trackpad 4 while maintaining contact with trackpad 4. According to some examples, mapping module 32 may not map this particular trackpad operation to a touchscreen event for processing by one or more of applications 10. Instead, mapping module 32 may pass this trackpad operation, and/or details/information associated therewith (including location and/or movement information associated with the single-touch movement gesture), to display pointer module 36.

Display pointer module 36 may process the information for the trackpad operation to update the current location of pointer 13 displayed via display device 12. Thus, in such fashion, a user can move and control the position of pointer 13 on display device 12 with respect to other content that is displayed, such that the user may subsequently interact with trackpad 4 to provide additional input with respect to content displayed by, with, or beneath pointer 13 (e.g., to select the content, to scroll the content, to zoom into or out of the content, as described above).

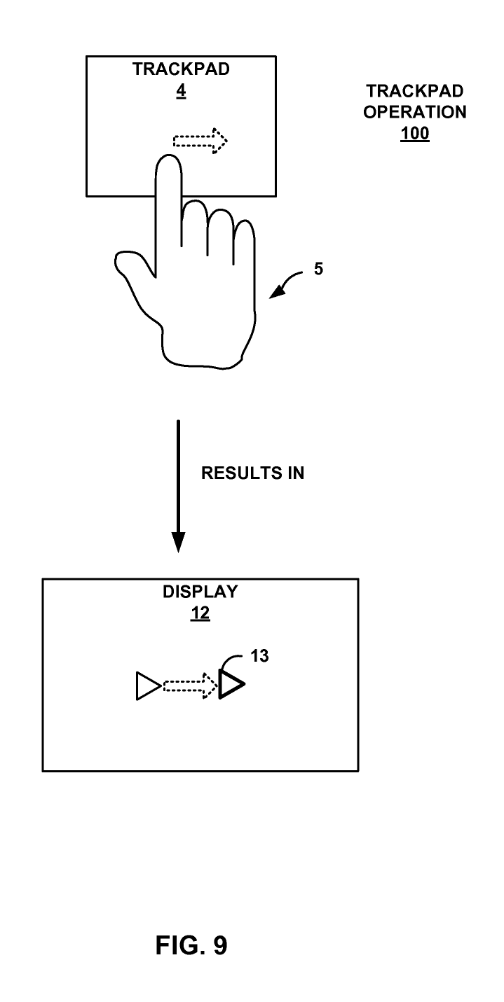

FIG. 9 is a conceptual diagram illustrating an example of a trackpad single-touch movement operation 100 that may cause movement of pointer 13 that is displayed via display device 12. As shown in FIG. 9, trackpad operation 100 comprises a single-gesture movement operation associated with movement of the index finger of hand 5 in a rightward direction from a first location to a second location via trackpad 4. Information associated with trackpad operation 100 may be provided to display pointer module 36 (FIG. 2), which may manage and update the position of pointer 13 on display 12 based upon the movement of the user's finger across trackpad 4.

FIG. 9 illustrates that the trackpad single-touch gesture results in movement of pointer 13 on display 12. FIG. 9 illustrates a representation of pointer 13 moving in a rightward direction, as displayed via display 12, based upon trackpad operation 100. Trackpad operation 100 is associated with rightward movement of the index finger of hand 5 on trackpad 4, and this may result in corresponding rightward movement of pointer 13 on display 12. The amount of movement of pointer 13 may, in some cases, be proportional the amount of movement of the index finger of hand 5 on trackpad 4, such as from a first location to a second location on trackpad 4. The amount of movement may be included in the information associated with trackpad operation 100 that is provided to display pointer module 36. Display pointer module 36 may then update the movement and position of pointer 13 on display 12.

As shown in FIG. 5, once the location of pointer 13 has been updated, it becomes located by, with, or above the content displayed on display 12 and shown in FIG. 9. The user may subsequently interact with trackpad 4 to initiate certain actions or instructions with respect to this content, such as by initiating a trackpad tap gesture, a trackpad multi-touch gesture comprising movement of multiple fingers substantially together from a first location to a second location, or a trackpad multi-touch gesture comprising movement of multiple fingers in different directions, as a few examples. As described above, such as in reference to FIG. 4, corresponding trackpad operations may be mapped to touchscreen events that may be processed by one or more of applications 10 with respect to the content displayed by, with, or beneath pointer 13 as shown in FIG. 9.

For instance, a trackpad tap operation may be mapped to a touchscreen tap event that is generated and processed by application 10A, which manages the content displayed via display 12, to select the content displayed next to pointer 13. A trackpad multi-touch gesture corresponding to multiple fingers moving together across trackpad 4 may be mapped to a touchscreen single-touch event that is generated and processed by application 10A to scroll or drag the content displayed next to pointer 13. A trackpad multi-touch gesture corresponding to multiple fingers moving in different directions across trackpad 4 may be mapped to a touchscreen multi-touch event that is generated and processed by application 10A to perform a pinch-zoom (e.g., zoom in, zoom out) operation with respect to the content.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in a computer-readable medium, such as a computer-readable storage medium, containing instructions. Instructions embedded or encoded in a computer-readable medium, including a computer-readable storage medium, may cause one or more programmable processors, or other processors, to implement one or more of the techniques described herein, such as when instructions included or encoded in the computer-readable medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may comprise one or more computer-readable storage media.

Various aspects of the disclosure have been described. These and other aspects are within the scope of the following claims.

1. A computer-readable storage medium comprising instructions that, when executed, cause one or more processors of a computing device to:
receive, via a trackpad device coupled to the computing device, touch-based input comprising one or more gestures, wherein the trackpad device is physically distinct from a display device coupled to the computing device;
determine a trackpad operation based upon the touch-based input;
determine a touchscreen event based upon a mapping of the trackpad operation to the touchscreen event, wherein the touchscreen event is determined without receiving any user input from a touchscreen device; and
generate the touchscreen event for processing by an application executing on the computing device, wherein the application is designed to process touchscreen events initiated by touchscreen devices.

2. The computer-readable storage medium of claim 1, wherein the touch-based input comprises multi-touch input, and wherein the trackpad operation comprises a multi-touch movement operation.

3. The computer-readable storage medium of claim 1, further comprising instructions that, when executed, cause the one or more processors of the computing device to:
receive, by a mapping module executing on the computing device, trackpad touch data corresponding to the touch-based input that is provided by a trackpad driver associated with the trackpad device,
wherein the mapping module performs the mapping of the trackpad operation to the touchscreen event.

4. The computer-readable storage medium of claim 3, wherein the instructions to generate the touchscreen event comprise instructions to provide, via an event generation module, mapped touch data corresponding to the touchscreen event to the application executing on the computing device.

5. The computer-readable storage medium of claim 1, further comprising instructions that, when executed, cause the one or more processors of the computing device to:
update content displayed via the display device based upon the processing of the touchscreen event by the application executing on the computing device.

6. The computer-readable storage medium of claim 1, wherein the instructions to generate the touchscreen event comprise instructions to generate the touchscreen event for processing by the application at a current location of a pointer that is displayed via the display device.

7. The computer-readable storage medium of claim 6, further comprising instructions that, when executed, cause the one or more processors of the computing device to:
determine a second trackpad operation corresponding to movement via the trackpad device based upon additional touch-based input; and
update the current location of the pointer that is displayed via the display device based upon the second trackpad operation.

8. The computer-readable storage medium of claim 6,
wherein the instructions to determine the trackpad operation comprise instructions to identify a trackpad tap operation based upon the touch-based input, and
wherein the instructions to determine the touchscreen event comprise instructions to determine a touchscreen tap event at the current location of the pointer that is displayed via the display device.

9. The computer-readable storage medium of claim 6,
wherein the instructions to determine the trackpad operation comprise instructions to identify a trackpad multi-touch movement operation from a first location to a second location based upon the touch-based input, the touch-based input comprising movement via the trackpad device of at least two user digits from the first location to the second location, and
wherein the instructions to determine the touchscreen event comprise instructions to determine a touchscreen single-touch event comprising movement from the first location to the second location relative to the current location of the pointer.

10. The computer-readable storage medium of claim 6,
wherein the instructions to determine the trackpad operation comprise instructions to identify a trackpad multi-touch movement operation in multiple directions based upon the touch-based input, the touch-based input comprising movement via the trackpad device of at least two user digits in the multiple directions, and
wherein the instructions to determine the touchscreen event comprise instructions to determine a touchscreen multi-touch event comprising movement in the multiple directions relative to the current location of the pointer.

11. The computer-readable storage medium of claim 1, wherein the computing device is also coupled to a separate touchscreen device.

12. A computing device, comprising:
one or more processors;
a trackpad driver operable by the one or more processors to receive, via a trackpad device coupled to the computing device, touch-based input comprising one or more gestures, wherein the trackpad device is physically distinct from a display device that is also coupled to the computing device;
an application operable by the one or more processors, the application being designed to process touchscreen events initiated by touchscreen devices;
means for determining a touchscreen event based upon a mapping from a trackpad operation that is based upon the touch-based input, wherein the touchscreen event is determined without receiving any user input from a touchscreen device; and
an event generation module operable by the one or more processors to generate the touchscreen event for processing by the application.

13. A method comprising:
receiving, via a trackpad device coupled to a computing device, touch-based input comprising one or more gestures, wherein the trackpad device is physically distinct from a display device coupled to the computing device;
determining, by the computing device, a trackpad operation based upon the touch-based input;
determining, by the computing device, a touchscreen event based upon a mapping of the trackpad operation to the touchscreen event, wherein the touchscreen event is determined without receiving any user input from a touchscreen device; and
generating, by the computing device, the touchscreen event for processing by an application executing on the computing device, wherein the application is designed to process touchscreen events initiated by touchscreen devices.

14. The method of claim 13, wherein the touch-based input comprises multi-touch input, and wherein the trackpad operation comprises a multi-touch movement operation.

15. The method of claim 13,
wherein determining the touchscreen event comprises receiving trackpad touch data corresponding to the touch-based input that is provided by a trackpad driver associated with the trackpad device, and
wherein generating the touchscreen event comprises providing mapped touch data corresponding to the touchscreen event to the application.

16. The method of claim 13, further comprising:
updating content displayed via the display device based upon the processing of the touchscreen event by the application.

17. The method of claim 13, further comprising:
determining a current location of a pointer that is displayed via the display device,
wherein generating the touchscreen event comprises generating the touchscreen event for processing by the application at the current location of the pointer.

18. The method of claim 17, further comprising:
updating the current location of the pointer that is displayed via the display device based upon a second trackpad operation that corresponds to movement via the trackpad device based upon additional touch-based input.

19. The method of claim 17,
wherein the trackpad operation comprises a trackpad tap operation, and
wherein determining the touchscreen event comprises determining a touchscreen tap event at the current location of the pointer.

20. The method of claim 17,
wherein the touch-based input comprises movement via the trackpad device of at least two user digits from a first location to a second location,
wherein the trackpad operation comprises a trackpad multi-touch movement operation from the first location to the second location based upon the touch-based input, and
wherein determining the touchscreen event comprises determining a touchscreen single-touch event comprising movement from the first location to the second location relative to the current location of the pointer.

21. The method of claim 17,
wherein the trackpad operation comprises a trackpad multi-touch movement operation in multiple directions based upon the touch-based input, the touch-based input comprising movement via the trackpad device of at least two user digits in the multiple directions, and
wherein determining the touchscreen event comprises determining a touchscreen multi-touch event comprising movement in the multiple directions relative to the current location of the pointer.

22. The method of claim 13, wherein the computing device is further coupled to a separate touchscreen device.
